(19) United States
(12) Patent Application Publication
(10) Pub. No.: US 2024/0052532 A1
(43) Pub. Date: Feb. 15, 2024

(54) LOW-THERMAL-SHRINKAGE POLYESTER INDUSTRIAL YARN AND PREPARATION METHOD THEREOF

(71) Applicant: JIANGSU HENGLI CHEMICAL FIBRE CO., LTD., Suzhou (CN)

(72) Inventors: Rui CHEN, Suzhou (CN); Lili WANG, Suzhou (CN); Shanshui WANG, Suzhou (CN); Damao YANG, Suzhou (CN); Ye ZHANG, Suzhou (CN); Xiaohua SUN, Suzhou (CN); Fangming TANG, Suzhou (CN); Tong WANG, Suzhou (CN)

(73) Assignee: JIANGSU HENGLI CHEMICAL FIBRE CO., LTD., Suzhou (CN)

(21) Appl. No.: 18/269,971

(22) PCT Filed: Aug. 25, 2021
(86) PCT No.: PCT/CN2021/114437

§ 371 Date: Jun. 28, 2023

(30) Foreign Application Priority Data
Dec. 29, 2020 (CN) 202011607943.2

(51) Int. Cl. D02G 3/02; D02G 3/44; D01D 5/098; D01F 6/84; C08G 63/80; C08G 63/685

(52) U.S. Cl. CPC D02G 3/02; D02G 3/44; D01D 5/0985; D01F 6/84; C08G 63/80; C08G 63/6856; D10B 2505/00; D10B 2331/04; D10B 2401/04; D10B 2401/063

(57) ABSTRACT

A low-thermal-shrinkage polyester industrial yarn and preparation method thereof are provided. The low-thermal-shrinkage polyester industrial yarn is prepared by spinning and winding a modified polyester after solid-state polycondensation to increase viscosity. The preparation method of the modified polyester includes: after uniformly mixing terephthalic acid, ethylene glycol, 2,5-pyridinedicarboxylic acid and copper chloride, successively performing an esterification reaction and a polycondensation reaction to obtain the modified polyester. The polyester segments of the prepared low-thermal-shrinkage polyester industrial yarn comprises a terephthalic acid segment, an ethylene glycol segment and a 2,5-pyridinedicarboxylic acid segment, and 2,5-pyridinedicarboxylic acid segments of different polyester segments are coordinated by Cu²⁺. The molar ratio of the terephthalic acid segment to the 2,5-pyridinedicarboxylic acid segment is 1:(0.03-0.05). The O atom on a carbonyl group and the N atom on the pyridine of the 2,5-pyridinedicarboxylic acid segment are involved in the coordination.

### CROSS REFERENCE TO THE RELATED APPLICATIONS

This application is the national phase entry of International Application No. PCT/CN2021/114437, filed on Aug. 25, 2021, which is based upon and claims priority to Chinese Patent Application No. 202011607943.2, filed on Dec. 29, 2020, the entire contents of which are incorporated herein by reference.

### TECHNICAL FIELD

The present invention belongs to the field of polyester fiber, and more particularly, relates to a low-thermal-shrinkage polyester industrial yarn and preparation method thereof.

### BACKGROUND

The high symmetry of the molecular chain structure of the polyester and the rigidity of the benzene ring make the product have good mechanical processing performance, chemical corrosion resistance, anti-microbial erosion performance and so on, and is widely applied to various fields such as fibers, films, and plastic products due to the advantages of relatively low price and easy recycling.

The thermal stability of the polyester is mainly manifested in two aspects, the ability to resist high temperature decomposition and the ability to resist higher environmental temperature when applied. The glass transition temperature is 70-76° C., the melting point is 250-260° C., and the thermal deformation temperature is 80-85° C. In order to meet the requirements of specific situations, the requirements for the performance of the industrial yarn are getting higher and higher, so that the polyester industrial yarn products need continuous innovation and research.

The disadvantage of the high-strength polyester industrial yarns is large thermal shrinkage, when the high-strength polyester industrial yarn is used for preparing tires, it is necessary to reduce the shrinkage rate and increase the modulus by adjusting the heat treatment condition of the cord fabric. With the increasing production of the polyester fiber, the quality of the fiber is increasingly demanding, often requiring excellent mechanical properties of the fiber, for example, fibers used in the preparation of automobile safety belts and sunshade cloths for household or industrial use, often requiring a lower dry-heat shrinkage rate, but due to the relatively large thermal shrinkage in the fibers prepared in the prior art, the application of the polyester industrial yarn is restricted.

It can be seen from the data of the polyester industry that the lower the shrinkage rate, the higher the crystallinity of the fiber, so to achieve a low shrinkage rate, the crystallinity of the yarn must be improved; the existing preparation process of the polyester industrial yarn mostly uses processes of spinning, multiple stretching and multiple shaping. On the one hand, high orientation is the structural basis for fiber materials to obtain high strength and high modulus; on the other hand, the high orientation system is also a thermodynamically unstable system entropy elasticity, which shows that the size of the fiber is unstable, that is, the fiber shrinks under the action of heat. Therefore, the requirements of both modulus and shrinkage performances on the structure are contradictory in nature. In the existing preparation process of the polyester industry, the shrinkage rate has reached a limit.

Therefore, it is an urgent problem to be solved to prepare a high-quality fiber with low shrinkage.

### SUMMARY

In order to solve the problem of certain limitations of how to reduce the shrinkage rate of the polyester industrial yarn in the prior art, the invention provides a low shrinkage polyester industrial yarn and preparation method thereof.

The invention solves the technical problem that the thermal shrinkage of the polyester industrial yarn in the prior art is relatively large, thereby restricting the application of the polyester industrial yarn.

The invention uses the coordination technology to reduce the thermal shrinkage rate of the polyester industrial yarn, so as to adapt to and broaden the application of the polyester industrial yarn.

To this end, the technical schemes of the invention are as follows: A low-thermal-shrinkage polyester industrial yarn, including: polyester segments of the low-thermal-shrinkage polyester industrial yarn includes a terephthalic acid segment, an ethylene glycol segment and a 2,5-pyridinedicarboxylic acid segment, and 2,5-pyridinedicarboxylic acid segments of different polyester segments are coordinated by Cu²⁺;
wherein the molar ratio of the terephthalic acid segment to the 2,5-pyridinedicarboxylic acid segment is 1:(0.03-0.05);
wherein the O atom on a carbonyl group and the N atom on the pyridine of the 2,5-pyridinedicarboxylic acid segment are involved in the coordination.

For complexes, factors such as the charge, the radius, the ionization potential, and the electronegativity of the central atom all affect the stability of the coordination, that is, the higher the charge of the central atom, the smaller the radius, the higher the charge potential, and the more stable the generated complex. When metal ions form complexes with N and O in pyridine, the stability constant increases gradually with the number of d electrons in the central atom, reaching the maximum value in copper.

The electronic configuration of the outer layer of copper is 3d(10)4s(1), generally, the copper loses two electrons, and the electronic configuration on the outer layer is 3d(9). Nine electrons occupy five d orbitals, and there will inevitably be a single electron on one orbital. Copper ions form tetracoordinated compounds because the energy of one d orbital, one s orbital, and two p orbitals is similar, and can be hybridized to form unequal dsp² hybridized orbitals, which can accommodate lone pair electrons of ligands and are easily coordinated with elements such as nitrogen, oxygen and so on to form stable complexes, forming a tetracoordinated compound.

The metal-ligand coordination interaction enhances the molecular interaction of macromolecular segments and hinders the movement of polymer chains. In the CuCl₂-doped polyester fiber, one core of Cu(II) contains two pyridine ligands, and the coordination structure of the two intermolecular pyridine ligands tends to promote the aggregation of polymer chains. The formation of the metal-ligand coordination interaction enhances the intermolecular interaction, making the polymer segment more likely to be frozen, reducing the movement of molecular chains, and requiring more energy to “thaw” the “frozen” segments, which increases the difficulty of deorientation of the amorphous region, thereby reducing the thermal shrinkage of the polyester industrial yarn.

For ligands, most of the commonly used ligands are carboxylic acid and nitrogen-containing ligands: the carboxyl groups in carboxylic acid ligands can have strong coordination and chelation capabilities with metal ions. The 2,5-pyridinedicarboxylic acid belongs to nitrogen heterocyclic aromatic carboxylic acid ligands, which integrates the advantages of aromatic carboxylic acid ligands and nitrogen-containing heterocyclic ligands, and pyridine heterocycles can be combined with a variety of metals to form more metal complexes because of good electron-donating and electron-accepting capabilities; it has a closed large a bond, and there is a pair of lone pair electrons on the sp² orbital of the N atom, which belongs to a non-centrosymmetric structure, and the conjugated electron donating and withdrawing groups can undergo charge transfer in the molecule, and it has a strong coordination ability, and its conjugation effect increases the stability of the complex.

Copper and 2,5-pyridinedicarboxylic acid forms two five-membered ring structure chelates. The chelate is a complex with a ring structure, and is obtained by chelating two or more ligands with the same metal ion to form a chelating ring. The stability of the chelate is closely related to the ring formation, which increases the stability of the chelate, wherein the five-membered ring and the six-membered ring are the most stable.

Since the coordination formed by copper with N and O is the most stable five-membered ring and six-membered ring, if the copper is coordinated with N and oxygen on the 4-position carbonyl, it is a seven-membered ring, which is unstable; copper forms a five-membered ring with N and oxygen on the 2-position carbonyl, and the coordination of copper is a tetracoordination, so the final formation is a chelate of two five-membered ring structures formed by copper and two 2,5-pyridine dicarboxylic acids.

The following preferred technology program is presented to give a detailed description for this invention: The said low-thermal-shrinkage polyester industrial yarn, wherein a coordination structure formed by Cu²⁺ coordination between 2,5-pyridinedicarboxylic acid segments of different polyester segments is:

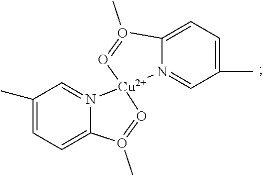

wherein a dry heat shrinkage rate of the low-thermal-shrinkage polyester industrial yarn at 177° C., 10 min and 0.05 cN/dtex is 2.2f0.3%;
wherein the performance indexes of the low-thermal-shrinkage polyester industrial yarn are as follows: a linear density deviation rate of ±1.5%, a breaking strength >7.8 cN/dtex, a breaking strength CV value 53.0%; a breaking elongation of 12.5-16.0%, a breaking elongation CV value <7.0%;

The present invention also provides a method of preparing the low-thermal-shrinkage polyester industrial yarn, wherein the low-thermal-shrinkage polyester industrial yarn is prepared by spinning and winding a modified polyester after solid-state polycondensation to increase viscosity;
wherein the preparation method of the modified polyester includes: after uniformly mixing terephthalic acid, ethylene glycol, 2,5-pyridinedicarboxylic acid and copper chloride, successively performing an esterification reaction and a polycondensation reaction to obtain the modified polyester.

In the invention, copper chloride is added during polymerization, because the metal-ligand interaction maintains the dynamic reversibility of the supramolecular bond while achieve the memory property of thermal responsiveness through reversible covalent cross-linking in the form of metal-ligand coordination bonds. The property is, when the polyester is at a certain temperature, the cross-linked node between molecular segments will be dissociated, and the cross-linked network node will be regenerated during the cooling process.

The diffusion of the coordination agent into polyester fibers can be described by the so-called channel and free-volume models. Above the glass transition temperature of the polyester fiber, the free volume inside the fiber is relatively large, containing many “holes” enough to accommodate the entry of the coordination agent, the coordination agent molecules diffuse through the “hole”, and the polyester fiber has multiple movements units, including side groups, segments, and the entire polymer chain, etc., when the coordination agent molecule diffuses into the fiber, the coordination agent molecule is gradually combined with the ligand of the fiber within a certain time to form a relatively stable coordination compound structure unit, which greatly affects the amorphous region of the fiber and effectively reduces the thermal motion of the segment in the amorphous region, thereby reducing the thermal shrinkage of the polyester industrial filament. The coordination treatment after winding is a method of coordination, which has minimal impact on fiber processing, but takes a longer time; on the other hand, the weak point of the fiber tends to be in the amorphous region, and the method of coordination treatment is optimal for the effect of improving the amorphous region. After Cu(II) is coordinated with pyridine, the anion can participate in the coordination or play a role of neutralizing the charge in the complex.

At the same time, due to the large crystallinity of the polyester industrial yarn, under the condition of 80-100° C., the crystallization region has not yet been changed due to the heating temperature, while the molecular segment of the amorphous region is optimally arranged in a small range, which will not bring adverse effects on the breaking strength and breaking elongation of the fiber.

The following preferred technology program is presented to give a detailed description for this invention:
In the method of preparing the low-thermal-shrinkage polyester industrial yarn, wherein the modified polyester is prepared in the following steps:
(1) Esterification
concocting terephthalic acid, ethylene glycol, 2,5-pyridinedicarboxylic acid and copper chloride into a slurry, adding a catalyst and a stabilizer and mixing uniformly, then carrying out the esterification under a nitrogen pressure ranged from atmospheric pressure to 0.3 MPa, the temperature of the esterification is 250-260° C., and the termination condition of the esterification is: when a water distillation amount reaches more than 90° % c of a theoretical value; the 2,5-pyridinedicarboxylic acid and the ethylene glycol perform the esterification under acid catalysis, and the carboxylic acid activity thereof is slightly greater than that of the terephthalic acid due to the conjugation effect, but it does not affect the esterification and no special adjustment is needed in the process;
(2) Polycondensation
after the esterification, starting a low vacuum stage of the polycondensation under a negative pressure, smoothly reducing the nitrogen pressure to below the absolute pressure of 500 Pa within 30-50 min, the temperature of the polycondensation is 250-260° C. and the time is 30-50 min, and then continue vacuuming to conduct a high vacuum stage of the polycondensation, further reducing the nitrogen pressure to below the absolute pressure of 100 Pa, the temperature of the polycondensation is 270-282° C. and the time is 50-90 min, and the modified polyester is obtained;
wherein the molar ratio of terephthalic acid, ethylene glycol and 2,5-pyridinedicarboxylic acid is 1:(1.2-2.0):(0.03-0.05), the addition amount of copper chloride is 20-30 mol % of 2,5-pyridinedicarboxylic acid, and the addition amount of the catalyst and the stabilizer is respectively 0.01-0.05 wt % and 0.01-0.05 wt % of the addition amount of terephthalic acid;
wherein the catalyst is antimony trioxide, ethylene glycol antimony or antimony acetate, and the stabilizer is triphenyl phosphate, trimethyl phosphate or trimethyl phosphite;
wherein the intrinsic viscosity of the modified polyester is 1.0-1.2 dUg after solid-state polycondensation to increase viscosity;
wherein the spinning process of the low-thermal-shrinkage polyester industrial yarn involves the following parameters:
a spinning temperature of 290-320° C.;
a side-blowing temperature of 23±2° C.;
a side-blowing humidity of 80±5%;
a side-blowing wind speed of 0.55±0.10 m/s;
a first godet roller speed of 460-600 m/min;
a second godet roller speed of 480-1000 m/min; a second godet roller temperature of 80-100° C.;
a third godet roller speed of 1800-2500 m/min; a third godet roller temperature of 100-150° C.;
a fourth godet roller speed of 2800-3500 m/min; a fourth godet roller temperature of 200-250° C.;
a fifth godet roller speed of 2800-3500 m/min; a fifth godet roller temperature of 200-250° C.;
a sixth godet roller speed of 2600-3400 m/min; a sixth godet roller temperature of 150-220° C.;
a winding speed of 2570-3360 m/min.

The mechanism of this invention is as follows:

For polyester industrial yarn, although the forming process is subject to high stress stretching and high temperature heat-setting, forming a highly crystalline and highly oriented structural feature, but due to the activity capability of the high-molecular-weight polyester molecular chain segment is limited (ie, the relaxation time is long), and the crystallization time in the thermal stretching and heat-setting process on the spinning process is limited, some segments that are not discharged into the crystal lattice are in a higher-energy straightening state or entanglement state, and stable “freezing” in this state at room temperature due to the decrease of temperature, far from reaching thermodynamic equilibrium state. Therefore, during the heating process of the polyester industrial yarn, that is, under the condition of 177° C., this part of the “frozen” segment first “thaws”, the activity capability is increased, that is, the deorientation of the amorphous region occurs, and the effect is especially obvious at a higher temperature and a shorter heating time, the occurrence of deorientation will lead to shrinkage of the fiber. At the same time, the shrinkage of the polyester industrial yarn is closely related to the degree of crystallinity and the integrity of crystallization.

In the invention, when the copper chloride molecules are dispersed into the fiber of the polyester industrial yarn, the copper chloride molecule and the ligand in the macromolecule are combined to form a relatively stable coordination structure unit, and the formation of the metal-ligand coordination interaction enhances intermolecular interaction and forms a physical cross-linking point, so that the “frozen” segment in the amorphous region forms a real “freeze”, effectively reduces the thermal movement of the segments in the amorphous region, which requires more energy to “thaw” the “frozen” segments, and increases the difficulty of deorientation in the amorphous region, thereby reducing the thermal shrinkage of the polyester industrial yarn; at the same time, the ligand used in the invention is 2,5-pyridinedicarboxylic acid, and when 2,5-pyridinedicarboxylic acid is introduced instead of terephthalic acid, the position of the two carboxyls is on the opposite side of the pyridine ring, and is highly similar to the terephthalic acid, reducing the influence on the structural regularity of the formed polyester, thereby will not affecting the degree of crystallinity and the integrity of crystallization.

From the thermodynamic perspective, the orientation decreases the entropy of the polymer system, thereby increasing the free energy, compared with the state before stretching, which is an unstable thermodynamic state that spontaneously converts into a non-oriented state-deorientation, and the speed of this process depends on kinetic factors. The polymer molecule motion unit has multiple properties, has different relaxation processes, and relies on temperature. Rapid cooling and quenching after drawing can “freeze” the orientation structure. If such a system is kept at a lower temperature, the rate of conversion to the equilibrium state is very slow, but at a higher temperature, the molecular motion is intensified, and the conversion rate of the system to the equilibrium state increases, which macroscopically appears as a shrinkage of the size. At the same time, the motions of various moving units of polymers are closely related to its stress state. There are interaction forces between molecular chains and within molecular chains; the macromolecular chains also have topological entanglement and physical entanglement, such as cohesive entanglement, microcrystals, etc., and the continuous polymer chains and the entanglements acting as physical crosslinks form a physical network structure. For oriented polymer materials such as crystallizable fibers, the possible influence of the presence of the crystalline region on the motion of segments in the amorphous region must be taken into account when analyzing their thermal shrinkage behavior.

In practical applications, polyester, due to the linear arrangement of molecular chains, is often subject to unavoidable effects on mechanical properties when heated because its segments are not supported by relatively strong cross-linking nodes. The cross-linking point can be a chemical cross-linking point or a physical cross-linking point, wherein the chemical cross-linking structure forms a stable intramolecular chemical bond, while the physical cross-linking structure includes hydrogen bonds, ionic bonds, and coordination bonds, etc.

Regardless of the physical cross-linking point or the chemical cross-linking point can effectively reduce the mobility of molecular segments, and the conversion rate of the system to the equilibrium state is reduced, which macroscopically appears as a reduction in the shrinkage rate of the size. At the same time, the stability of the cross-linking point is conducive to improving the interaction force between the molecular chains of the cross-linking point, which is beneficial to reducing the shrinkage rate.

Benefits:
(1) The preparation method of the low-thermal-shrinkage polyester industrial yarn of the present invention, Cu(II)-pyridine coordination plays a key role in the enhanced physical dots, reducing the thermal shrinkage rate of the polyester fiber;
(2) The low-thermal-shrinkage polyester industrial yarn of the present invention, the dry heat shrinkage rate at 177° C., 10 min and 0.05 cN/dtex is 2.2±0.3%;
(3) The low-thermal-shrinkage polyester industrial yarn of the present invention, has good breaking strength and breaking elongation while maintaining relatively low thermal shrinkage, thereby broadening the application of the polyester industrial yarn.

### DETAILED DESCRIPTION OF THE EMBODIMENTS

Based on above mentioned method, the following embodiments are carried out for further demonstration in the present invention. It is to be understood that these embodiments are only intended to illustrate the invention and are not intended to limit the scope of the invention. In addition, it should be understood that after reading the contents described in the present invention, those technical personnel in this field can make various changes or modifications to the invention, and these equivalent forms also fall within the scope of the claims attached to the application.

### EXAMPLE 1

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (antimony trioxide) and the stabilizer (triphenyl phosphate) and mixing uniformly, the molar ratio of terephthalic acid, ethylene glycol and 2,5-pyridinedicarboxylic acid is 1:1.2:0.03, the addition amount of copper chloride is 20 mol % of 2,5-pyridinedicarboxylic acid, and the addition amount of the catalyst and the stabilizer is respectively 0.01 wt % and 0.02 wt % of the addition amount of terephthalic acid, then carrying out the esterification under the nitrogen pressure of 0.2 MPa, the temperature of the esterification is 250° C., and the termination condition of the esterification is: when the water distillation amount reaches 90% of the theoretical value;
(1.2) Polycondensation
after the esterification, starting a low vacuum stage of the polycondensation under the negative pressure, smoothly reducing the nitrogen pressure to the absolute pressure of 480 Pa within 35 min, the temperature of the polycondensation is 254° C. and the time is 45 min, and then continue vacuuming to conduct a high vacuum stage of the polycondensation, further reducing the nitrogen pressure to the absolute pressure of 10 Pa, the temperature of the polycondensation is 275° C. and the time is 60 min, and the modified polyester is obtained:
(2) spinning and winding the modified polyester after solid-state polycondensation to increase viscosity, to obtain the low-thermal-shrinkage polyester industrial yarn;
wherein the intrinsic viscosity of the modified polyester is 1 dL/g after solid-state polycondensation to increase viscosity;
wherein the spinning process involves the following parameters:
a spinning temperature of 290° C.;
a side-blowing temperature of 21° C.;
a side-blowing humidity of 75%;
a side-blowing wind speed of 0.45 m/s;
a first godet roller speed of 460 m/min;
a second godet roller speed of 480 m/min; a second godet roller temperature of 80° C.;
a third godet roller speed of 1800 m/min; a third godet roller temperature of 100° C.;
a fourth godet roller speed of 2800 m/min; a fourth godet roller temperature of 200° C.;
a fifth godet roller speed of 2800 m/min; a fifth godet roller temperature of 200° C.;
a sixth godet roller speed of 2600 m/min; a sixth godet roller temperature of 150° C.;
a winding speed of 2570 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.03; the 2,5-pyridinedicarboxylic acid segments of different polyester segments are coordinated by Cu², and the O atom on a carbonyl group and the N atom on the pyridine of the 2,5-pyridinedicarboxylic acid segment are involved in the coordination; the coordination structure formed by coordination is:

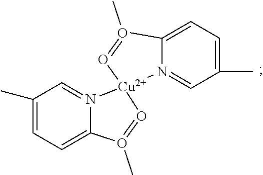

the low-thermal-shrinkage polyester industrial yarn has a linear density deviation rate of −1.5%, a breaking strength of 7.8 cN/dtex, a breaking strength CV value of 2.7%, a breaking elongation of 16%, a breaking elongation CV value of 6.4%, and a dry heat shrinkage rate of 2.5% at 177° C., 10 min and 0.05 cN/dtex.

### EXAMPLE 2

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (antimony trioxide) and the stabilizer (triphenyl phosphate) and mixing uniformly, the molar ratio of terephthalic acid, ethylene glycol and 2,5-pyridinedicarboxylic acid is 1:1.2:0.04, the addition amount of copper chloride is 22 mol % of 2,5-pyridinedicarboxylic acid, and the addition amount of the catalyst and the stabilizer is respectively 0.02 wt % and 0.01 wt % of the addition amount of terephthalic acid, then carrying out the esterification under the nitrogen pressure of 0.1 MPa, the temperature of the esterification is 252° C., and the termination condition of the esterification is: when the water distillation amount reaches 95% of the theoretical value;
(1.2) Polycondensation
after the esterification, starting a low vacuum stage of the polycondensation under the negative pressure, smoothly reducing the nitrogen pressure to the absolute pressure of 490 Pa within 35 min, the temperature of the polycondensation is 252° C. and the time is 50 min, and then continue vacuuming to conduct a high vacuum stage of the polycondensation, further reducing the nitrogen pressure to the absolute pressure of 30 Pa, the temperature of the polycondensation is 272° C. and the time is 80 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1 dUg after solid-state polycondensation to increase viscosity;
wherein the spinning process involves the following parameters:
a spinning temperature of 295° C.;
a side-blowing temperature of 21° C.;
a side-blowing humidity of 76%;
a side-blowing wind speed of 0.47 m/s;
a first godet roller speed of 480 m/min;
a second godet roller speed of 550 m/min; a second godet roller temperature of 85° C.;
a third godet roller speed of 2000 m/min; a third godet roller temperature of 110° C.;
a fourth godet roller speed of 2900 m/min; a fourth godet roller temperature of 210° C.;
a fifth godet roller speed of 2900 m/min; a fifth godet roller temperature of 210° C.;
a sixth godet roller speed of 2900 m/min; a sixth godet roller temperature of 160° C.;
a winding speed of 2870 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.04; the 2,5-pyridinedicarboxylic acid segments of different polyester segments are coordinated by Cu²⁺, and the O atom on a carbonyl group and the N atom on the pyridine of the 2,5-pyridinedicarboxylic acid segment are involved in the coordination; the coordination structure formed by coordination is:

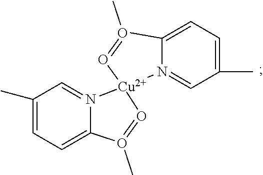

the low-thermal-shrinkage polyester industrial yarn has a linear density deviation rate of −1%, a breaking strength of 8 cN/dtex, a breaking strength CV value of 2.75%, a breaking elongation of 14.7%, a breaking elongation CV value of 6.3%, and a dry heat shrinkage rate of 2.2% at 177° C., 10 min and 0.05 cN/dtex.

### EXAMPLE 3

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (ethylene glycol antimony) and the stabilizer (trimethyl phosphate) and mixing uniformly, the molar ratio of terephthalic acid, ethylene glycol and 2,5-pyridinedicarboxylic acid is 1:1.2:0.05, the addition amount of copper chloride is 22 mol % of 2,5-pyridinedicarboxylic acid, and the addition amount of the catalyst and the stabilizer is respectively 0.02 wt % and 0.02 wt % of the addition amount of terephthalic acid, then carrying out the esterification under the nitrogen pressure of 0.2 MPa, the temperature of the esterification is 254° C., and the termination condition of the esterification is: when the water distillation amount reaches 95% of the theoretical value;
(1.2) Polycondensation
after the esterification, starting a low vacuum stage of the polycondensation under the negative pressure, smoothly reducing the nitrogen pressure to the absolute pressure of 500 Pa within 30 min, the temperature of the polycondensation is 250° C. and the time is 50 min, and then continue vacuuming to conduct a high vacuum stage of the polycondensation, further reducing the nitrogen pressure to the absolute pressure of 25 Pa, the temperature of the polycondensation is 274° C. and the time is 70 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1 dUg after solid-state polycondensation to increase viscosity;
wherein the spinning process involves the following parameters;
a spinning temperature of 300° C.;
a side-blowing temperature of 22° C.:
a side-blowing humidity of 78%;
a side-blowing wind speed of 0.5 m/s;
a first godet roller speed of 500 m/min;
a second godet roller speed of 650 m/min; a second godet roller temperature of 90° C.;
a third godet roller speed of 2200 m/min; a third godet roller temperature of 120° C.;
a fourth godet roller speed of 3000 m/min; a fourth godet roller temperature of 220° C.;
a fifth godet roller speed of 3000 m/min; a fifth godet roller temperature of 220° C.;
a sixth godet roller speed of 3000 m/min; a sixth godet roller temperature of 170° C.;
a winding speed of 2960 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.05; the 2,5-pyridinedicarboxylic acid segments of different polyester segments are coordinated by Cu²⁺, and the O atom on a carbonyl group and the N atom on the pyridine of the 2,5-pyridinedicarboxylic acid segment are involved in the coordination; the coordination structure formed by coordination is;

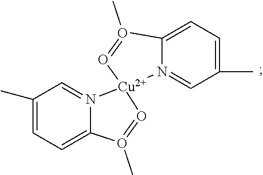

the low-thermal-shrinkage polyester industrial yarn has a linear density deviation rate of −0.5%, a breaking strength of 8.3 cN/dtex, a breaking strength CV value of 2.8%, a breaking elongation of 12.8%, a breaking elongation CV value of 6.5%, and a dry heat shrinkage rate of 2% at 177° C., 10 min and 0.05 cN/dtex.

### EXAMPLE 4

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (ethylene glycol antimony) and the stabilizer (trimethyl phosphate) and mixing uniformly, the molar ratio of terephthalic acid, ethylene glycol and 2,5-pyridinedicarboxylic acid is 1:2:0.03, the addition amount of copper chloride is 26 mol % of 2,5-pyridinedicarboxylic acid, and the addition amount of the catalyst and the stabilizer is respectively 0.03 wt % and 0.04 wt % of the addition amount of terephthalic acid, then carrying out the esterification under the nitrogen pressure of 0.25 MPa, the temperature of the esterification is 255° C., and the termination condition of the esterification is: when the water distillation amount reaches 96% of the theoretical value;
(1.2) Polycondensation
after the esterification, starting a low vacuum stage of the polycondensation under the negative pressure, smoothly reducing the nitrogen pressure to the absolute pressure of 460 Pa within 40 min, the temperature of the polycondensation is 255° C. and the time is 40 min, and then continue vacuuming to conduct a high vacuum stage of the polycondensation, further reducing the nitrogen pressure to the absolute pressure of 15 Pa, the temperature of the polycondensation is 270° C. and the time is 90 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1.1 dUg after solid-state polycondensation to increase viscosity;
wherein the spinning process involves the following parameters:
a spinning temperature of 305° C.;
a side-blowing temperature of 23° C.;
a side-blowing humidity of 79%;
a side-blowing wind speed of 0.55 m/s;
a first godet roller speed of 510 m/min;
a second godet roller speed of 750 m/min; a second godet roller temperature of 92° C.;
a third godet roller speed of 2300 m/min; a third godet roller temperature of 125° C.;
a fourth godet roller speed of 3100 m/min; a fourth godet roller temperature of 230° C.;
a fifth godet roller speed of 3100 m/min; a fifth godet roller temperature of 230° C.;
a sixth godet roller speed of 3100 m/min; a sixth godet roller temperature of 180° C.;
a winding speed of 3070 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.03; the 2,5-pyridinedicarboxylic acid segments of different polyester segments are coordinated by Cu², and the O atom on a carbonyl group and the N atom on the pyridine of the 2,5-pyridinedicarboxylic acid segment are involved in the coordination; the coordination structure formed by coordination is:

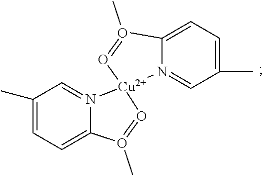

the low-thermal-shrinkage polyester industrial yarn has a linear density deviation rate of −0.4%, a breaking strength of 7.9 cN/dtex, a breaking strength CV value of 2.9%, a breaking elongation of 15.6%, a breaking elongation CV value of 6.6%, and a dry heat shrinkage rate of 2.4% at 177° C., 10 min and 0.05 cN/dtex.

### EXAMPLE 5

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (antimony acetate) and the stabilizer (trimethyl phosphite) and mixing uniformly, the molar ratio of terephthalic acid, ethylene glycol and 2,5-pyridinedicarboxylic acid is 1:2.0:0.04, the addition amount of copper chloride is 24 mol % of 2,5-pyridinedicarboxylic acid, and the addition amount of the catalyst and the stabilizer is respectively 0.03 wt % and 0.05 wt % of the addition amount of terephthalic acid, then carrying out the esterification under the nitrogen pressure of 0.25 MPa, the temperature of the esterification is 256° C., and the termination condition of the esterification is: when the water distillation amount reaches 96% of the theoretical value;
(1.2) Polycondensation
after the esterification, starting a low vacuum stage of the polycondensation under the negative pressure, smoothly reducing the nitrogen pressure to the absolute pressure of 450 Pa within 45 min, the temperature of the polycondensation is 256° C. and the time is 35 min, and then continue vacuuming to conduct a high vacuum stage of the polycondensation, further reducing the nitrogen pressure to the absolute pressure of 25 Pa, the temperature of the polycondensation is 278° C. and the time is 55 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1.1 dUg after solid-state polycondensation to increase viscosity;
wherein the spinning process involves the following parameters:
a spinning temperature of 310° C.;
a side-blowing temperature of 24° C.;
a side-blowing humidity of 80%;
a side-blowing wind speed of 0.57 m/s;
a first godet roller speed of 550 m/min;
a second godet roller speed of 850 m/min; a second godet roller temperature of 96° C.;
a third godet roller speed of 2400 m/min; a third godet roller temperature of 140° C.;
a fourth godet roller speed of 3200 m/min; a fourth godet roller temperature of 240° C.;
a fifth godet roller speed of 3200 m/min; a fifth godet roller temperature of 240° C.;
a sixth godet roller speed of 3200 m/min; a sixth godet roller temperature of 190° C.;
a winding speed of 3150 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.04; the 2,5-pyridinedicarboxylic acid segments of different polyester segments are coordinated by Cu-+, and the O atom on a carbonyl group and the N atom on the pyridine of the 2,5-pyridinedicarboxylic acid segment are involved in the coordination; the coordination structure formed by coordination is:

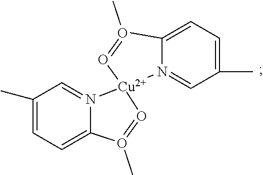

the low-thermal-shrinkage polyester industrial yarn has a linear density deviation rate of 0.2%, a breaking strength of 8.1 cN/dtex, a breaking strength CV value of 2.8%, a breaking elongation of 13.9%, a breaking elongation CV value of 6.9%, and a dry heat shrinkage rate of 2.1% at 177° C., 10 min and 0.05 cN/dtex.

### EXAMPLE 6

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (antimony acetate) and the stabilizer (trimethyl phosphite) and mixing uniformly, the molar ratio of terephthalic acid, ethylene glycol and 2,5-pyridinedicarboxylic acid is 1:2.0:0.04, the addition amount of copper chloride is 28 mol % of 2,5-pyridinedicarboxylic acid, and the addition amount of the catalyst and the stabilizer is respectively 0.04 wt % and 0.03 wt % of the addition amount of terephthalic acid, then carrying out the esterification under the nitrogen pressure of 0.3 MPa, the temperature of the esterification is 258° C., and the termination condition of the esterification is: when the water distillation amount reaches 97% of the theoretical value;
(1.2) Polycondensation
after the esterification, starting a low vacuum stage of the polycondensation under the negative pressure, smoothly reducing the nitrogen pressure to the absolute pressure of 440 Pa within 45 min, the temperature of the polycondensation is 258° C. and the time is 35 min, and then continue vacuuming to conduct a high vacuum stage of the polycondensation, further reducing the nitrogen pressure to the absolute pressure of 30 Pa, the temperature of the polycondensation is 280° C. and the time is 55 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1.2 dUg after solid-state polycondensation to increase viscosity;
wherein the spinning process involves the following parameters:
a spinning temperature of 315° C.;
a side-blowing temperature of 24° C.;
a side-blowing humidity of 83%;
a side-blowing wind speed of 0.6 m/s;
a first godet roller speed of 580 m/min;
a second godet roller speed of 950 m/min; a second godet roller temperature of 98° C.;
a third godet roller speed of 2450 m/min; a third godet roller temperature of 145° C.;
a fourth godet roller speed of 3400 m/min; a fourth godet roller temperature of 245° C.;
a fifth godet roller speed of 3400 m/min; a fifth godet roller temperature of 245° C.:
a sixth godet roller speed of 3300 m/min; a sixth godet roller temperature of 210° C.;
a winding speed of 3260 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.04; the 2,5-pyridinedicarboxylic acid segments of different polyester segments are coordinated by Cu²′, and the O atom on a carbonyl group and the N atom on the pyridine of the 2,5-pyridinedicarboxylic acid segment are involved in the coordination; the coordination structure formed by coordination is:

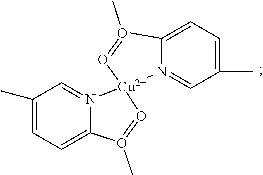

the low-thermal-shrinkage polyester industrial yarn has a linear density deviation rate of 0.9%, a breaking strength of 8.4 cN/dtex, a breaking strength CV value of 2.95%, a breaking elongation of 13.5%, a breaking elongation CV value of 6.7%, and a dry heat shrinkage rate of 2% at 177° C., 10 min and 0.05 cN/dtex.

### EXAMPLE 7

A method of preparing the low-thermal-shrinkage polyester industrial yarn, including the following steps:
(1)Preparation of the Modified Polyester
(1.1) Esterification
concocting terephthalic acid, ethylene glycol, 2,5-pyridinedicarboxylic acid and copper chloride into a slurry, adding the catalyst (antimony acetate) and the stabilizer (trimethyl phosphite) and mixing uniformly, the molar ratio of terephthalic acid, ethylene glycol and 2,5-pyridinedicarboxylic acid is 1:2.0:0.05, the addition amount of copper chloride is 30 mol % of 2,5-pyridinedicarboxylic acid, and the addition amount of the catalyst and the stabilizer is respectively 0.05 wt % and 0.03 wt % of the addition amount of terephthalic acid, then carrying out the esterification under the nitrogen pressure of 0.3 MPa, the temperature of the esterification is 260° C., and the termination condition of the esterification is: when the water distillation amount reaches 98% of the theoretical value;
(1.2) Polycondensation
after the esterification, starting a low vacuum stage of the polycondensation under the negative pressure, smoothly reducing the nitrogen pressure to the absolute pressure of 400 Pa within 50 min, the temperature of the polycondensation is 260° C. and the time is 30 min, and then continue vacuuming to conduct a high vacuum stage of the polycondensation, further reducing the nitrogen pressure to the absolute pressure of 10 Pa, the temperature of the polycondensation is 282° C. and the time is 50 min, and the modified polyester is obtained;
(2) spinning and winding the modified polyester after solid-state polycondensation to increase viscosity, to obtain the low-thermal-shrinkage polyester industrial yarn;
wherein the intrinsic viscosity of the modified polyester is 1.2 dug after solid-state polycondensation to increase viscosity;
wherein the spinning process involves the following parameters:
a spinning temperature of 320° C.;
a side-blowing temperature of 25° C.;
a side-blowing humidity of 85%;
a side-blowing wind speed of 0.65 m/s;
a first godet roller speed of 600 m/min;
a second godet roller speed of 1000 m/min; a second godet roller temperature of 100° C.;
a third godet roller speed of 2500 m/min; a third godet roller temperature of 150° C.;
a fourth godet roller speed of 3500 m/min; a fourth godet roller temperature of 250° C.;
a fifth godet roller speed of 3500 m/min; a fifth godet roller temperature of 250° C.;
a sixth godet roller speed of 3400 m/min; a sixth godet roller temperature of 220° C.;
a winding speed of 3360 m/min.

The polyester segments of the prepared low-thermal-shrinkage polyester industrial yarn includes the terephthalic acid segment, the ethylene glycol segment and the 2,5-pyridinedicarboxylic acid segment, the molar ratio of the terephthalic acid segment to the 2,5-pyridinedicarboxylic acid segment is 1:0.05; the 2,5-pyridinedicarboxylic acid segments of different polyester segments are coordinated by Cu²⁺, and the O atom on a carbonyl group and the N atom on the pyridine of the 2,5-pyridinedicarboxylic acid segment are involved in the coordination; the coordination structure formed by coordination is:

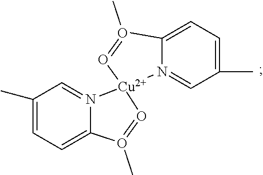

the low-thermal-shrinkage polyester industrial yarn has a linear density deviation rate of 1.5%, a breaking strength of 8.5 cN/dtex, a breaking strength CV value of 3%, a breaking elongation of 12.5%, a breaking elongation CV value of 7%, and a dry heat shrinkage rate of 1.9% at 177° C., 10 min and 0.05 cN/dtex.

What is claimed is:

1. A low-thermal-shrinkage polyester industrial yarn, wherein polyester segments of the low-thermal-shrinkage polyester industrial yarn comprise a terephthalic acid segment, an ethylene glycol segment and a 2,5-pyridinedicarboxylic acid segment, and 2,5-pyridinedicarboxylic acid segments of different polyester segments are coordinated by Cu²⁺;
wherein a molar ratio of the terephthalic acid segment to the 2,5-pyridinedicarboxylic acid segment is 1:(0.03-0.05); and
wherein the O atom on a carbonyl group and the N atom on the pyridine of the 2,5-pyridinedicarboxylic acid segment are involved in the coordination.

2. The low-thermal-shrinkage polyester industrial yarn of claim 1, wherein a coordination structure formed by Cu²⁺ coordination between 2,5-pyridinedicarboxylic acid segments of different polyester segments is:

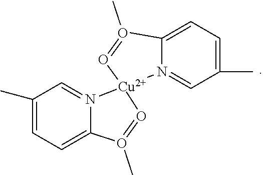

3. The low-thermal-shrinkage polyester industrial yarn of claim 1, wherein a dry heat shrinkage rate of the low-thermal-shrinkage polyester industrial yarn at 177° C., 10 min and 0.05 cN/dtex is 2.2±0.3%.

4. The low-thermal-shrinkage polyester industrial yarn of claim 1, wherein performance indexes of the low-thermal-shrinkage polyester industrial yarn are as follows: a linear density deviation rate of +1.5%, a breaking strength >7.8 cN/dtex, a breaking strength CV value <3.0%; a breaking elongation of 12.5-16.0%, a breaking elongation CV value <7.0%.

5. A method of preparing a low-thermal-shrinkage polyester industrial yarn, wherein the low-thermal-shrinkage polyester industrial yarn is prepared by spinning and winding a modified polyester after solid-state polycondensation to increase viscosity;
wherein a preparation method of the modified polyester comprises: after uniformly mixing terephthalic acid, ethylene glycol, 2,5-pyridinedicarboxylic acid and copper chloride, successively performing an esterification reaction and a polycondensation reaction to obtain the modified polyester.

6. The method of claim 5, wherein the modified polyester is prepared in the following steps:
(1) esterification
concocting terephthalic acid, ethylene glycol, 2,5-pyridinedicarboxylic acid and copper chloride into a slurry, adding a catalyst and a stabilizer and mixing uniformly, then carrying out the esterification under a nitrogen pressure ranged from atmospheric pressure to 0.3 MPa, a temperature of the esterification is 250-260° C., and a termination condition of the esterification is: when a water distillation amount reaches more than 90% of a theoretical value; and
(2) polycondensation
after the esterification, starting a low vacuum stage of the polycondensation under a negative pressure, smoothly reducing the nitrogen pressure to below an absolute pressure of 500 Pa within 30-50 min, a temperature of the polycondensation is 250-260° C. and a time is 30-50 min, and then continue vacuuming to conduct a high vacuum stage of the polycondensation, further reducing the nitrogen pressure to below an absolute pressure of 100 Pa, the temperature of the polycondensation is 270-282° C. and the time is 50-90 min, and the modified polyester is obtained.

7. The method of claim 6, wherein a molar ratio of terephthalic acid, ethylene glycol and 2,5-pyridinedicarboxylic acid is 1:(1.2-2.0):(0.03-0.05), an addition amount of copper chloride is 20-30 mol % of 2,5-pyridinedicarboxylic acid, and an addition amount of the catalyst and the stabilizer is respectively 0.01-0.05 wt % and 0.01-0.05 wt % of 4 an addition amount of terephthalic acid.

8. The method of claim 7, wherein the catalyst is antimony trioxide, ethylene glycol antimony or antimony acetate, and the stabilizer is triphenyl phosphate, trimethyl phosphate or trimethyl phosphite.

9. The method of claim 5, wherein an intrinsic viscosity of the modified polyester is 1.0-1.2 dL/g after solid-state polycondensation to increase viscosity.

10. The method of claim 5, wherein a spinning process of the low-thermal-shrinkage polyester industrial yarn involves the following parameters:
a spinning temperature of 290-320° C.;
a side-blowing temperature of 23±2° C.;
a side-blowing humidity of 80±5%;
a side-blowing wind speed of 0.55±0.10 m/s;
a first godet roller speed of 460-600 m/min;
a second godet roller speed of 480-1000 m/min; a second godet roller temperature of 80-100° C.;
a third godet roller speed of 1800-2500 m/min; a third godet roller temperature of 100-150° C.;
a fourth godet roller speed of 2800-3500 m/min; a fourth godet roller temperature of 200-250° C.;
a fifth godet roller speed of 2800-3500 m/min; a fifth godet roller temperature of 200-250° C.;
a sixth godet roller speed of 2600-3400 m/min; a sixth godet roller temperature of 150-220° C.; and
a winding speed of 2570-3360 m/min.
